(19) United States
(12) Patent Application Publication
(10) Pub. No.: US 2024/0001527 A1
(43) Pub. Date: Jan. 4, 2024

(54) STUD FINDING DRILL METHOD AND APPARATUS

(71) Applicants: JAMES DARCHE, HENDERSON, KY (US); MCCORMICK THOMASINA, HENDERSON, KY (US)

(72) Inventors: JAMES DARCHE, HENDERSON, KY (US); MCCORMICK THOMASINA, HENDERSON, KY (US)

(21) Appl. No.: 18/341,042

(22) Filed: Jun. 26, 2023

Related U.S. Application Data
(60) Provisional application No. 63/473,916, filed on Jul. 2, 2022.

(51) Int. Cl. B25F 5/02; B25B 23/00; G01V 3/165; G01N 27/26

(52) U.S. Cl. CPC B25F 5/02; B25B 23/00; G01V 3/165; G01N 27/26

(57) ABSTRACT

A device that integrates the functions of a stud-finder and drill into a single handheld system is provided. The device for locating a hidden structural member (stud) and inserting a fastener through a substrate member (drywall) into the hidden structural member includes a fastening tool and a sensor assembly. The fastening tool includes a housing and means for driving the fastener through the substrate and into the structural member. The sensor assembly may be affixed to the housing of the fastening tool and comprises a sensor for detecting the hidden structural member through the substrate member. An indicator in communication with the sensor is configured to notify a user when the sensor detects the hidden structural member. A method for locating a hidden structural member and inserting a fastener through a substrate member into the hidden structural member is also provided.

### BACKGROUND OF THE INVENTION

### Field of the Invention

This disclosure relates generally to methods and apparatuses for drilling screws through a surface into a structural member, and more particularly to a method and apparatus for locating a structural member and drilling screws thorough a surface into the structural member using a single device.

### Description of the Related Art

Manual laborers involved in the construction of buildings, specifically the handing of drywall are challenged to complete tasks quickly with few mistakes. A mistake, such as driving a screw through drywall, but missing the structural member behind the wall results in a cascade of repairs. Precise knowledge of stud location and other items behind the wall improves this work quality while reducing rework (production time is decreased).

A stud-finder is a known tool which employs various sensors and procedures to locate structural members within a wall. Drills are also known tools which assist in quickly driving screws. Working with both devices is cumbersome for a single individual, as it requires multiple hands & steps to locate, mark and drive screws.

Accordingly, there is a need for a unitary or combined device that allows a user to quickly and easily perform the stud finding and drilling functions in a more efficient manner.

### SUMMARY OF THE INVENTION

It is therefore an object of the present invention to provide a device that combines the features of a stud finder and drill into a single unitary or combined device.

It is also an object of the invention to provide a method of sensing a structural member such as a wall stud and driving a fastener such as a screw into the wall stud with a single device.

The present invention meets these objects by providing a device that integrates the function of a stud-finder and the function of a drill into a single handheld system. The most useful combination of the system accounts for several design variants, including: A stud-finding drill in which all functions are integrated into a single appliance; and a stud-finding drill designed as separate devices which can be joined to work together yet operate independently if needed for the task at hand.

According to one presently preferred embodiment of the invention, there is provided a device for locating a hidden structural member and inserting a fastener through a substrate member into the hidden structural member comprising a fastening tool and a sensor assembly. The fastening tool includes a housing and means for driving the fastener through the substrate and into the structural member. The sensor assembly may be affixed to the housing of the fastening tool and comprises a sensor for detecting the hidden structural member through the substrate member. An indicator in communication with the sensor is configured to notify a user when the sensor detects the hidden structural member.

The sensor assembly may be fixedly attached to an upper surface of the housing of the fastening tool. The sensor may be provided in an upper surface of the sensor assembly and is oriented perpendicular relative to the fastener when it is engaged by the driving means of the fastening tool, and the indicator is provided in a lower surface of the sensor assembly.

The sensor assembly may alternatively comprise a first member having the sensor located in a first surface thereof. The first member may include a plurality of shafts extending from a second, opposing surface. Each shaft passes through a corresponding opening in a second member that is affixed to the upper surface of the housing of the fastening tool. A spring surrounding each one of the plurality of shafts may be provided for biasing the first member away from the second member.

The sensor assembly may alternatively comprise an elongated first member having the sensor located in a first surface at a first end thereof, and a pivot block affixed to the upper surface of the housing. A second end of the first member may be pivotally connected to the pivot block. A spring may be associated with the pivot block for biasing the first member toward a closed position.

The sensor assembly may alternatively comprise a first member housing the sensor, a first flexible arm member and a second flexible arm member. The first flexible arm member may have a first end attached to a first end of the first member and a second end pivotally attached to a first side of the fastening tool housing. The second flexible arm member may have a first end attached to a second end of the first member and a second end pivotally attached to a second opposing side of the fastening tool housing.

The sensor assembly may alternatively comprise a spring housing, a sensor housing, and a spring. The spring housing may include a first end configured to engage the housing of the fastening tool. The sensor housing may have a first end configured to slidably engage a second end of the spring housing, and a second end for carrying said sensor. The spring may be positioned between and attached to the spring housing and sensor housing for biasing the sensor housing away from the spring housing. The indicator may comprise a plurality of indicators positioned about a perimeter of the sensor housing. One of the plurality of indicators may be located at the top center of the sensor housing for indicating that the device is aligned with the stud.

The fastening tool may be a cordless drill and the fastener is a threaded screw. The cordless drill may include a trigger for activating the driving means of the drill when fully engaged and for activating the sensor when partially engaged. A battery may be removably connected to the cordless drill for providing power to the driving means and the sensor. The indicator may be located on a rear surface of the fastening tool housing. The sensor may comprise an electronic stud finder that emits a magnetic beam that penetrates the substrate and differentiates between hollow space and solid space behind the substrate.

According to another aspect of the invention, there is provided a method for locating a hidden structural member and inserting a fastener through a substrate member into the hidden structural member. A sensor located in a sensor assembly affixed to a housing of a fastening tool is placed in proximity with the substrate member. The sensor is then activated to detect the hidden structural member through the substrate member. The fastening tool and sensor are moved along a surface of the substrate until an indicator in communication with the sensor notifies a user that the sensor has located and is in alignment with the hidden structural member. Driving means associated with the fastening tool are then activated to drive the fastener through the substrate and into the structural member. The fastening tool is then pressed toward the substrate to embed the fastener into the substrate and hidden structural member.

The method may further include the step of marking a surface of the substrate at a location where the sensor and indicator indicated the presence of a hidden structural member prior to activating the driving means. The method may further include the step of removing the sensor from the substrate surface prior to activating the driving means.

The step of moving the fastening tool and sensor may include moving the fastening tool and sensor until an indicator located at the top center of the sensor housing indicates that the fastening tool and sensor are aligned with the hidden structural member. The step of pressing the fastening tool toward the substrate may include pressing the fastening tool against bias of a spring positioned between and attached to a spring housing that is attached to a housing of the fastening tool and a sensor housing until the fastener is embedded in the substrate and the hidden structural member. The step of activating the sensor may be done by partially engaging a trigger associated with the fastening tool and the step of activating the driving means may be done by fully engaging the trigger.

According to a further aspect of the invention, there is provided a sensor assembly for locating a hidden structural member for use in connection with a fastening tool. The fastening tool includes a housing and means for driving a fastener through a substrate and into the structural member. The sensor assembly comprises a sensor for detecting the hidden structural member through the substrate member; an indicator in communication with said sensor, said indicator configured to notify a user when the sensor detects said hidden structural member; and mounting means for removably affixing the sensor assembly to the fastening tool.

The mounting means may comprise a spring housing having a first end configured to releasably engage the housing of the fastening tool; a sensor housing having a first end configured to slidably engage a second end of the spring housing, and a second end for carrying said sensor; and a spring positioned between and attached to the spring housing and sensor housing for biasing the sensor housing away from the spring housing.

The indicator may comprise a plurality of indicators positioned about a perimeter of the sensor housing. One of the plurality of indicators may be located at the top center of the sensor housing for indicating that the device is aligned with the stud. The fastening tool may be a cordless drill and the fastener may be a threaded screw. The sensor may comprise an electronic stud finder that emits a magnetic beam that penetrates the substrate and differentiates between hollow space and solid space behind the substrate.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a side/front perspective view in elevation of a stud finding drill apparatus according to one presently preferred embodiment of the invention.

FIG. 2 is a side/front perspective view in elevation of stud finding drill apparatus according a first alternative embodiment of the present invention.

FIG. 3 is a side/front perspective view in elevation of stud finding drill apparatus according a second alternative embodiment of the present invention.

FIG. 4 is a side/front perspective view in elevation of stud finding drill apparatus according a third alternative embodiment of the present invention.

FIG. 5A is a side/rear perspective view in elevation of stud finding drill apparatus according a fourth alternative embodiment of the present invention.

FIG. 5B is a side/rear perspective view in elevation of the stud finding drill apparatus shown in FIG. 5A with the sensor assembly shown in exploded view.

FIG. 6A is side sectional view of the stud finding drill apparatus shown in FIG. 5A and FIG. 5B.

FIG. 6B is a rear elevational view of the stud finding drill apparatus shown in FIG. 5A and FIG. 5B.

### DETAILED DESCRIPTION OF THE INVENTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

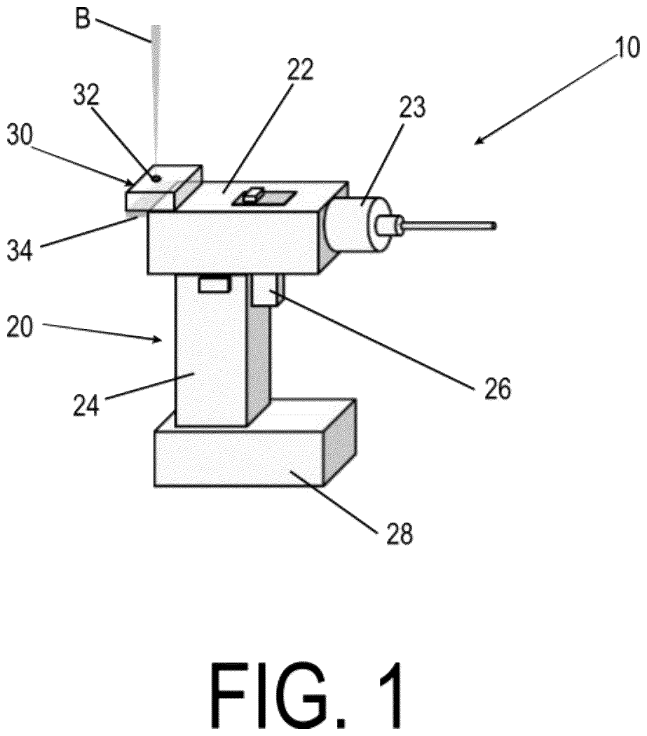

As best shown in FIG. 1, one presently preferred embodiment of the invention comprises a stud finding drill apparatus 10 comprising a drill 20 and an integrated sensor assembly 30. The stud finding drill 10 includes a standard drill, preferably a cordless drill 20 having a body 22 housing a motor (not shown) for imparting rotary motion to a chuck 23, a handle 24 that allows the stud finding drill apparatus 10 to be held by a user, a trigger 26 for engaging the rotary motor to impart rotary motion to the chuck 23, and a removeable, rechargeable battery 28 for providing power to the motor. These features are common to all embodiments wherein like reference numbers indicate like components. Other features commonly associated with cordless drills are shown, but do not necessarily contribute to the present invention.

For the embodiment shown in FIG. 1, the integrated sensor assembly 30 is fixedly mounted to an upper surface of the drill body 22. The sensor 32 of the integrated sensor assembly 30 faces upwardly relative to the drill 20 and the indicator 34 faces downwardly. In operation, the stud finding drill apparatus 10 is rotated 90 degrees from the position shown in FIG. 1 so that surface of the sensor 32 is in contact with the wall and the beam B is directed toward the wall to detect a stud in the wall. Once the stud is found, it may be marked in various ways. It may be marked visually. Additionally, it may operate manually with a marker, or semi-automatically by use of a control input to place a mark on the wall. One additional option is to mark the wall automatically once the stud-finder function is satisfied. The indicator which signals the location of a stud may indicate by a plurality of methods. It may be visual such as light indicators, audible using as beeps & frequencies, or tactile using vibration. Thereafter, the user then pivots the tool 90 degrees and the drill 20 can be used to install a screw in the stud location identified by the sensor 32.

The sensor assembly 30 functions in the same manner as a traditional stud finder as known in the prior art. According to a preferred embodiment of the invention, the sensor assembly 30 is an electronic stud finder. Electronic stud finders are battery-powered devices that find studs by sensing changes in the density of the wall. Pressing a button on the device creates a magnetic field. This field sends feedback to the device when the density changes, like going from a hollow area to an area with a stud. The device displays a light or it beeps, or both. Edge stud finders signal when the device hits the left or right edge of a stud. Center or whole-stud finders cast multiple magnetic fields that capture the entire width of the stud and beyond. In the present embodiment of the invention, the sensor 32 emits a magnetic field or beam B which penetrates the drywall and differentiates between hollow cavities and a stud. When the sensor 32 detects a stud, the indicator 34 is activated to notify the user that the drill 10 is aligned with a stud in the wall and a screw can be driven into the wall. Usage of the drill in this configuration requires that the drill be rotated and pressed to be flat with the wall for the sensor to work properly. This motion for sensor alignment requires a 90 degrees rotation of the drill while operating the stud-finding function. The feedback indicators (if visual) shall be in line-of-site while held in this position and shall be design in an ergonomically friendly way.

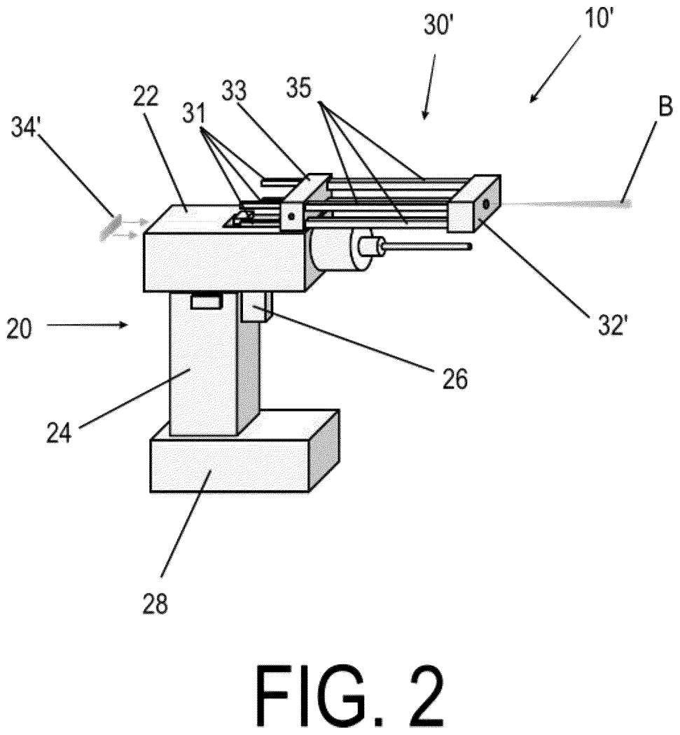

FIG. 2 shows a stud finding drill apparatus 10′ according to an alternative embodiment of the invention comprising a drill 20 and an integrated linear, spring biased sensor assembly 30′. The linear, spring biased sensor assembly 30′ is also mounted to an upper surface of the drill body 22, and includes a sensor 32′ that emits a magnetic field or beam B, and an indicator 34′ for signaling a user as to when the drill is aligned with a stud in the wall. A plurality of shafts 31 extend from a rear surface of the sensor 32′ toward the rear of the drill and are slidably received in openings in a block 33 affixed to the upper surface of the drill body 22. Each shaft 31 is encircled by a spring 35 between the rear surface of the sensor 32′ and a front surface of the block 33 so as to bias the sensor 32′ away from the block 33 toward the front of the drill assembly 10. The stud finding drill apparatus 10′ of FIG. 2 operates similar to the drill apparatus 10 shown in FIG. 1 and described above. The front surface of the sensor 32′ is placed against the surface of the wall and the device 10′ is moved until such time as the indicator 34′ indicates that the system 10′ is aligned with a stud in the wall. With a screw in the chuck of the drill, the trigger is engaged to impart rotary motion to the chuck and screw. The drill 20 may then be moved toward the wall to insert the screw into the wall and stud. As the drill 20 is moved toward the wall, the springs 35 are compressed. Once the screw is fully embedded in the wall and stud, the drill assembly 10 may be withdrawn from engagement with the wall. Usage of the drill in this configuration requires that the sensor contacts the wall prior to the drill-tip, yet the sensor must depress away from the wall as the drill protrudes through the plain of the wall. The feedback indicators (if visual) shall be in line-of-site while held in this position and shall be design in an ergonomically friendly way.

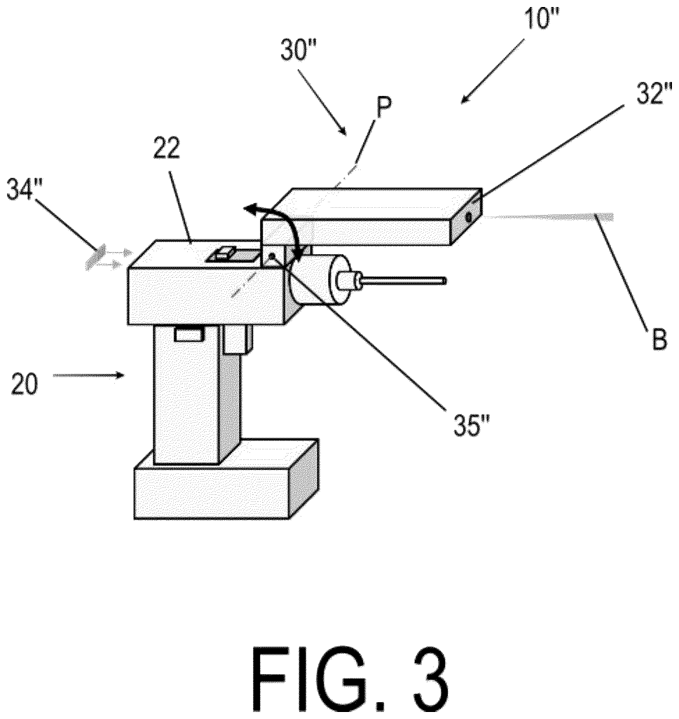

FIG. 3 shows a stud finding drill apparatus 10′ according to a second alternative embodiment of the invention comprising a drill 20 and an integrated pivoting, spring biased sensor assembly 30″. The pivoting, spring biased sensor assembly 30″ is also mounted to an upper surface of the drill body 22, and includes a sensor 32″ that emits a magnetic field or beam B, and an indicator 34″ for signaling a user as to when the drill is aligned with a stud in the wall. The sensor 32″ is pivotally mounted atop the upper surface 22 of the drill via a pivot block 35″ which allows the sensor to pivot about axis P. The pivot block 35″ may include a spring that biases the sensor 32″ away from the position shown in FIG. 3. The stud finding drill apparatus of FIG. 3 operates similar to the drill apparatus 10 shown in FIG. 1 and described above. The front surface of the sensor 32′ is placed against the surface of the wall and the device 10″ is moved until such time as the indicator 34″ indicates that the system 10″ is aligned with a stud in the wall. Once the stud is located, the sensor 32″ can be pivoted about the pivot block 35″ such that the sensor 32″ is no longer engaging the wall. With a screw in the chuck of the drill, the trigger is engaged to impart rotary motion to the chuck and screw. The drill 20 may then be moved toward the wall to insert the screw into the wall and stud. Once the screw is fully embedded in the wall and stud, the drill assembly 10 may be withdrawn from engagement with the wall. Usage of the drill in this configuration requires that the sensor contacts the wall prior to the drill-tip, yet the sensor must pivot and slide away from the wall as the drill protrudes through the plain of the wall. The feedback indicators (if visual) shall be in line-of-site while held in this position and shall be design in an ergonomically friendly way.

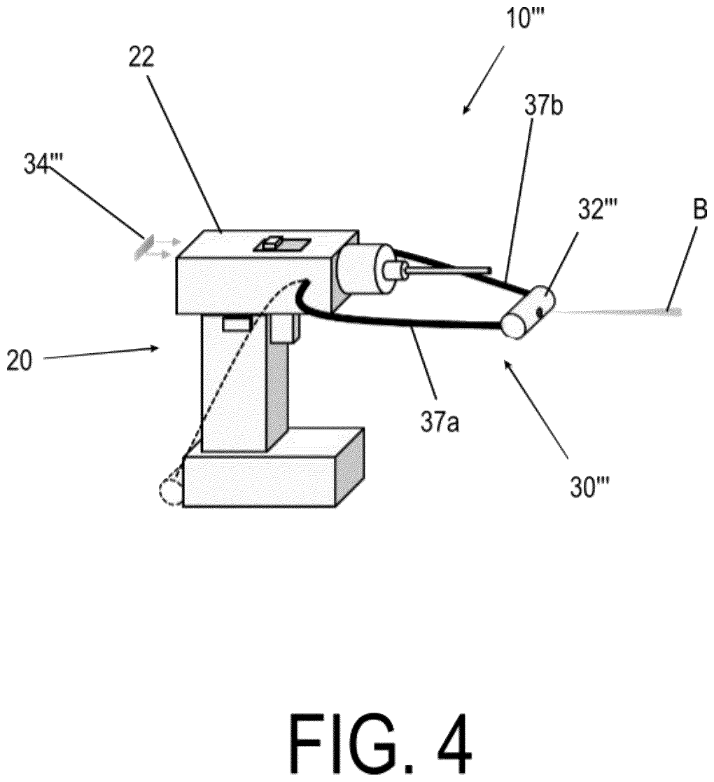

FIG. 4 shows a stud finding drill apparatus 10′″ according to a third alternative embodiment of the invention comprising a drill 20 and flexible, multi-positional sensor assembly 30″. The flexible, multi-positional sensor assembly 30′″ includes a sensor 32′″ and flexible arms 37a, 37b extending from either side thereof and connected to the sides of the drill body 22. The flexible, multi-positional sensor assembly 30′″ can be rotated from a forward position and a rear, stowed position (shown in dashed lines). The stud finding drill apparatus 10′″ of FIG. 4 operates similar to the drill apparatus 10 shown in FIG. 1 and described above. The front surface of the sensor 32′″ is placed against the surface of the wall and the device 10′″ is moved until such time as the indicator 34′″ indicates that the system 10′″ is aligned with a stud in the wall. Once the stud is located, the sensor 32′″ can be pivoted about pivot arms 37a, 37b from the forward position to the rear stored position such that the sensor 32′″ is no longer engaging the wall. With a screw in the chuck of the drill, the trigger is engaged to impart rotary motion to the chuck and screw. The drill 20 may then be moved toward the wall to insert the screw into the wall and stud. Once the screw is fully embedded in the wall and stud, the drill assembly 10 may be withdrawn from engagement with the wall. In one of several adjustable forward positions, it shall be configured such that the sensor extends beyond the tip of the drill, as shown in FIG. 4. Usage of the drill in this configuration requires that the sensor contacts the wall prior to the drill-tip, yet the sensor must flex away from the wall as the drill protrudes through the plain of the wall. The feedback indicators (if visual) shall be in line-of-site while held in this position and shall be design in an ergonomically friendly way. A second position of the sensor allows it to stow in a rear location that does not interfere with drilling when the stud-finding function is not needed.

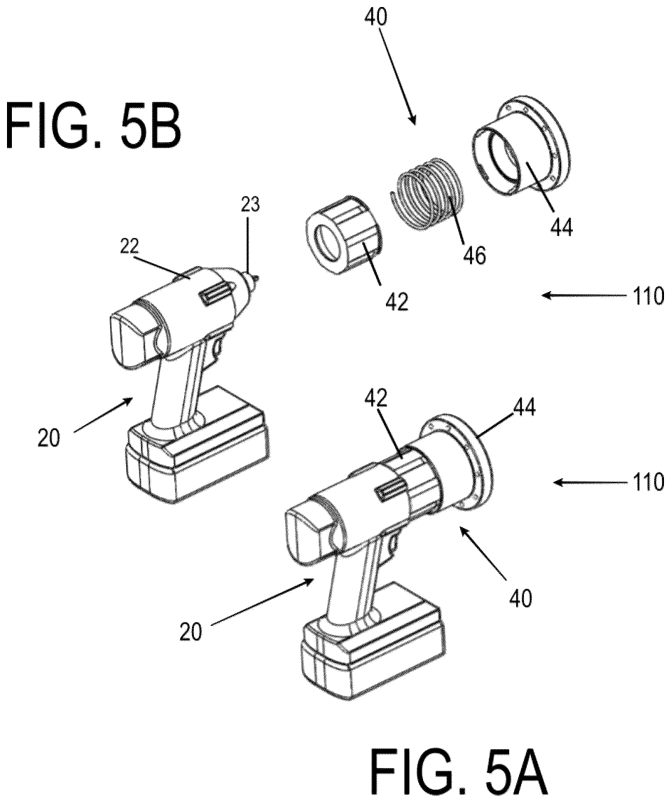

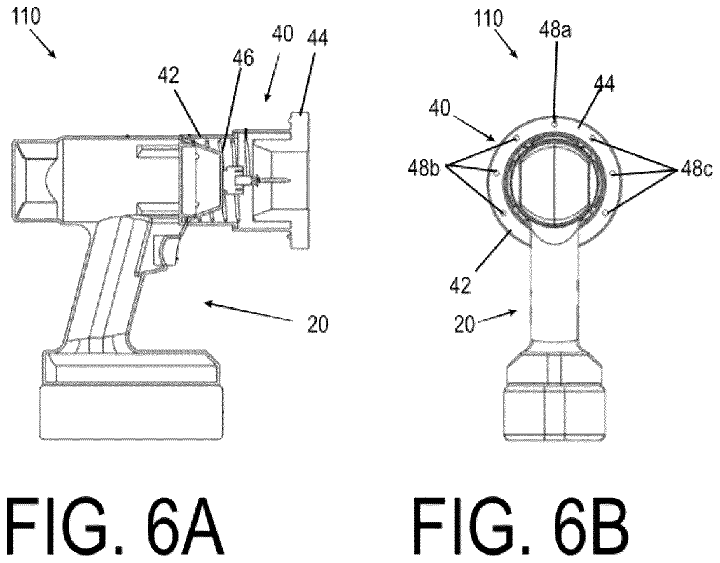

FIG. 5A, FIG. 5B, FIG. 6A and FIG. 6B show a linear, spring-biased stud finding drill apparatus 110 according to a fourth alternative embodiment of the invention comprising a drill 20 and removable sensor assembly 40. Rather than being integrated with the drill 20, the sensor assembly 40 according to this embodiment is removable from the drill 20 and is designed to be used as a separate attachment to a standard, pre-existing drill 20. The removable sensor assembly includes a sensor assembly 42, a spring housing 44 and a spring 46. The spring housing 44 is designed to frictionally engage an outer surface of the drill housing 22 and surround the chuck 23. The sensor assembly 44 fits around the spring housing 42 such that an outer surface of the spring housing 42 is slideably received within an opening in the sensor assembly 44. The spring 46 has a first end that engages a surface in the spring housing 42 and a second end that engages a surface within the sensor assembly 44 such that the spring biases the sensor assembly 44 away from the spring housing 42. One or more sensors (not shown) are located on a front surface of the sensor assembly 44 in the same manner as shown in the previous embodiments. A rear surface of a flange portion of the sensor assembly 44 is provided with a plurality of indicators 48a, 48b, 48c. In operation, the front surface of the sensor assembly 44 is placed against the surface of the wall and the device 110 is moved laterally along the wall until such time as the center indicator 48a indicates that the system 110 is aligned with a stud in the wall The left lateral indicators 48b and right lateral indicators 48c are configured to illuminate when they are in alignment with the stud, thus notifying the user that the device 110 is nearly aligned with the stud. Once the stud is aligned, with a screw in the chuck of the drill, the trigger is engaged to impart rotary motion to the chuck and screw. The drill 20 may then be moved toward the wall to insert the screw into the wall and stud. Once the screw is fully embedded in the wall and stud, the drill assembly 110 may be withdrawn from engagement with the wall. The drill head and chuck 23 shall protrude through the center channel of the removable sensor assembly 40 as needed to when drilling or driving. The total depth of protrusion may be limited by adjustments made to the sensor assembly 44, and spring housing 42.

In all of the above-described embodiments, control of the various stud-finder-drill functions can be integrated into the drill trigger 26, which have various positions to communicate input to the system. For example, a slight depression of the trigger 26 could activate the stud-finder function. A further depression of the trigger 26 could activate the drill and drive function. Power to the system for all embodiments is preferably supplied by a DC battery 28 that is removably attached to the drill 20.

Integration of this combined stud-finder-drill must account for material selection for impact strength, temperature stability, tactile grip and slip-agent where needed. Geometry shall allow for sensor access but shall avoid sharp edges which may impact walls causing adverse effects on workmanship. The power of the system must be integrated such that voltage & wattage are balanced & meet the needs of the input sensors, logic board, output drivers & capacity of the battery. The control unit shall be in proximity such that one-handed operation is possible. Multi-level settings of triggers, switches and control knobs shall start/stop each discrete function. Feedback sensors shall vary in frequency and intensity as needed for each required feedback.

The execution of a stud-finder and a drill as two appliances, each working together shall embody all the functions and features as described in the integrated system. There shall be additional considerations for operation as two appliances. Unique system shall each operate on stand-alone battery systems, or they shall share power form a common source when attached. That attachment shall be by electrical contacts or wireless pick-up coils. Communication between each appliance shall also be through contacts or by wireless communications.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I claim:

1. A device for locating a hidden structural member and inserting a fastener through a substrate member into the hidden structural member comprising:
a. a fastening tool having a housing and means for driving the fastener through the substrate and into the structural member; and
b. a sensor assembly affixed to the housing of the fastening tool, said sensor assembly comprising a sensor for detecting the hidden structural member through the substrate member, and an indicator in communication with said sensor, said indicator configured to notify a user when the sensor detects said hidden structural member.

2. The device according to claim 1, wherein the sensor assembly is fixedly attached to an upper surface of the housing of the fastening tool.

3. The device according to claim 2, wherein the sensor is provided in an upper surface of the sensor assembly and is oriented perpendicular relative to the fastener when it is engaged by the driving means of the fastening tool, and the indicator is provided in a lower surface of the sensor assembly.

4. The device according to claim 2 wherein the sensor assembly comprises a first member having the sensor located in a first surface thereof, said first member having a plurality of shafts extending from a second, opposing surface, each of said shafts passing through a corresponding opening in a second member that is affixed to the upper surface of the housing of the fastening tool; and a spring surrounding each one of the plurality of shafts for biasing the first member away from the second member.

5. The device according to claim 2 wherein the sensor assembly comprises an elongated first member having the sensor located in a first surface at a first end thereof, and a pivot block affixed to the upper surface of the housing, a second end of the first member being pivotally connected to the pivot block, and a spring associated with the pivot block for biasing the first member toward a closed position.

6. The device according to claim 1 wherein the sensor assembly comprises
a. a first member housing said sensor;
b. a first flexible arm member having a first end attached to a first end of the first member and a second end pivotally attached to a first side of the fastening tool housing; and
c. a second flexible arm member having a first end attached to a second end of the first member and a second end pivotally attached to a second opposing side of the fastening tool housing.

7. The device according to claim 1 wherein the indicator is affixed to a rear surface of the housing of the fastening tool.

8. The device according to claim 1 wherein the sensor assembly comprises:
a. a spring housing having a first end configured to engage the housing of the fastening tool;
b. a sensor housing having a first end configured to slidably engage a second end of the spring housing, and a second end for carrying said sensor; and
c. a spring positioned between and attached to the spring housing and sensor housing for biasing the sensor housing away from the spring housing.

9. The device according to claim 8 wherein said indicator comprises a plurality of indicators positioned about a perimeter of the sensor housing, one of said plurality of indicators being located at the top center of the sensor housing for indicating that the device is aligned with the stud.

10. The device according to claim 1 wherein the fastening tool is a cordless drill and the fastener is a threaded screw.

11. The device according to claim 10 wherein the cordless drill includes a trigger for activating the driving means of the drill when fully engaged and for activating the sensor when partially engaged.

12. The device according to claim 10 further comprising a battery removably connected to the cordless drill for providing power to the driving means and the sensor.

13. The device according to claim 1 wherein the indicator is located on a rear surface of the fastening tool housing.

14. The device according to claim 1 wherein the sensor comprises an electronic stud finder that emits a magnetic beam that penetrates the substrate and differentiates between hollow space and solid space behind the substrate.

15. A method for locating a hidden structural member and inserting a fastener through a substrate member into the hidden structural member comprising the steps of:
a. placing a sensor located in a sensor assembly affixed to a housing of a fastening tool in proximity with the substrate member;
b. activating said sensor to detect the hidden structural member through the substrate member;
c. moving the fastening tool and sensor along a surface of the substrate until an indicator in communication with said sensor notifies a user that the sensor has located and is in alignment with the hidden structural member;
d. activating driving means associated with the fastening tool to drive the fastener through the substrate and into the structural member; and
e. pressing the fastening tool toward the substrate to embed the fastener into the substrate and hidden structural member.

16. The method for locating and inserting according to claim 15 further comprising the step of marking a surface of the substrate at a location where the sensor and indicator indicated the presence of a hidden structural member prior to activating the driving means.

17. The method for locating and inserting according to claim 16, further comprising the step of removing the sensor from the substrate surface prior to activating the driving means.

18. The method for locating and inserting according to claim 15 wherein the step of moving the fastening tool and sensor comprises moving the fastening tool and sensor until an indicator located at the top center of the sensor housing indicates that the fastening tool and sensor are aligned with the hidden structural member.

19. The method for locating and inserting according to claim 18 wherein the step of pressing the fastening tool toward the substrate comprises pressing the fastening tool against bias of a spring positioned between and attached to a spring housing that is attached to a housing of the fastening tool and a sensor housing until the fastener is embedded in the substrate and the hidden structural member.

20. The method for locating and inserting according to claim 19 wherein the step of activating said sensor is done by partially engaging a trigger associated with said fastening tool and the step of activating said driving means is done by fully engaging said trigger.

21. A sensor assembly for locating a hidden structural member for use in connection with a fastening tool, said fastening tool having a housing and means for driving a fastener through a substrate and into the structural member, said sensor assembly comprising:
a. a sensor for detecting the hidden structural member through the substrate member;
b. an indicator in communication with said sensor, said indicator configured to notify a user when the sensor detects said hidden structural member; and
c. mounting means for removably affixing the sensor assembly to the fastening tool.

22. The device according to claim 21 wherein the mounting means comprises:
a. a spring housing having a first end configured to releasably engage the housing of the fastening tool;
b. a sensor housing having a first end configured to slidably engage a second end of the spring housing, and a second end for carrying said sensor; and
c. a spring positioned between and attached to the spring housing and sensor housing for biasing the sensor housing away from the spring housing.

23. The device according to claim 22 wherein said indicator comprises a plurality of indicators positioned about a perimeter of the sensor housing, one of said plurality of indicators being located at the top center of the sensor housing for indicating that the device is aligned with the stud.

24. The device according to claim 21 wherein the fastening tool is a cordless drill and the fastener is a threaded screw.

25. The device according to claim 21 wherein the sensor comprises an electronic stud finder that emits a magnetic beam that penetrates the substrate and differentiates between hollow space and solid space behind the substrate.
